(19) United States
(12) Patent Application Publication
(10) Pub. No.: US 2016/0363691 A1
(43) Pub. Date: Dec. 15, 2016

(54) PHYSICAL SIMULATION METHOD AND EXPERIMENT DEVICE OF FRACTURE-CAVITY CARBONATE RESERVOIR HYDROCARBON CHARGE

(71) Applicant: PetroChina Company Limited, Beijing (CN)

(72) Inventors: Suyun Hu, Beijing (CN); Shuyuan Shi, Beijing (CN); Hua Jiang, Beijing (CN); Tongshan Wang, Beijing (CN); Qingchun Jiang, Beijing (CN)

(21) Appl. No.: 14/984,507

(22) Filed: Dec. 30, 2015

(30) Foreign Application Priority Data
Jun. 15, 2015 (CN) 201510328950.1

(51) Int. Cl. G01V 8/10; G01V 1/34; H04N 5/225

(52) U.S. Cl. CPC G01V 8/10; H04N 5/225; G01V 1/345

(57) ABSTRACT

The present invention provides a physical simulation experiment device of fracture-cavity carbonate reservoir hydrocarbon charge. The experiment device comprises a fracture-cavity model, an experiment stand with windows, a wall rock and a camera monitoring system; the fracture-cavity model comprises simulation caves in different sizes and simulation fractures in different sizes; the simulation caves are connected to one another via the simulation fractures; the fracture-cavity model is arranged inside the experiment stand with windows, and the simulation caves of at least one side of the fracture-cavity model are visual through the windows of the experiment stand; a surrounding of the wall rock is arranged around the fracture-cavity model to simulate a formation of fracture-cavity carbonate reservoir; the camera monitoring system is used for measuring and adjusting changes in flow rate and pressure in a charge process, and recording an image of fracture and cave in the charge process displayed in the windows. The present invention further provides a physical simulation method of fracture-cavity carbonate reservoir hydrocarbon charge, which uses the above-mentioned experiment device. The present invention can obtain regularities of distribution of oil, gas and water through parameters such as karsts, fractures, density of cruel oil, and oil, gas and water distribution and the like.

### TECHNICAL FIELD

The present invention relates to a physical simulation method and experiment device of fracture-cavity carbonate reservoir hydrocarbon charge, and pertains to a technical field of petroleum gas exploration.

### BACKGROUND

A fracture-cavity carbonate reservoir is a class of important reservoir space in oil-gas exploration in China, the reservoir and permeation space of this class of reservoir mainly consists of karst caves in different sizes with widely different geometric forms and fractures of different widths. The fracture-cavity reservoir is formed by an action of carbonate karst, wherein karst caves and cavers are main reservoir space of hydrocarbon, and Structural fractures and Dissolution fractures are constructed as a reservoir system of fluid flowing passage. Owing to an extremely complicated composition relation among fractures and cavities, extremely strong inhomogeneous characteristics are embodied, and a special permeability rule exists when fluid flows therein. A physical simulation is an important means of study of the permeability rule, physical simulation techniques for conventional porosity reservoir, compact reservoir and the like in clastic rock are well developed at present. However, since significant differences exist in flow rules between fracture-cavity reservoir and conventional clastic rock reservoir, it has great difficulties in studying the permeability rule thereof and the hydrocarbon accumulation process thereof, and even has greater difficulties in quantitative research. Currently, the research is bound by a monitoring and observation in a fluid-filling process and an acquisition of data such as pressure, flow rate, filling degree and the like, thus the regularity thereof cannot be effectively recognized, and it becomes one of bottleneck problems that restrict a hydrocarbon exploration for such a class of reservoir.

At present, attempts of physical simulation of fracture-cavity reservoir have been made by domestic scholars for multiple times, for instance, the physical simulation experiment in which artificial etching and displacement of oil by water are performed through a real core by Zheng Xiaomin et al. (89-93, 32(2), 2010, Journal of Southwest Petroleum University; physical simulation study on displacement mechanism of oil by water of fracture-cavity carbonate oil reservoir [J], Zheng Xiaomin, Sun Lei et al.); study on oil-water migration and accumulation process in fractured media by applying a glass laser etching, Tang Xuan et al. (570-576, 52 (4), 2006, Geological Review, physical simulation experiment study on microcosmic two-dimensional oil-water migration and accumulation in carbonate fractured media); simulating an oil-gas migration and accumulation process of fracture system having different network topologies by applying a light etching glass model, KANG Yongshang et al. (44-47, 24(4), 2003, Acta Petrolei Sinica, simulation experiment study on petroleum migration in fractured media [J]. KANG Yongshang, GUO Qianjie, ZHU Jiucheng et al.); study on water displacing oil microcosmic mechanism by applying a light etching microscopic glass plane model, LI Jianglong et al. (637˜641, 31(6), 2009, Petroleum Geology and Experiment, water displacing oil microcosmic experiment simulation study on fracture-cavity carbonate oil reservoir, LI Jianglong, CHEN Zhihai, et al.). However, in general, it is still unclear about the simulation cognition of hydrocarbon charging process of fracture-cavity system, particularly the hydrocarbon charging process of large karst caves exceeding the size of the core and fracture system. Difficult points are mainly reflected in four aspects as follows: (1) lacking systemic and effective experimental observation instruments and equipments, not capable of monitoring and recording a real-time change of parameters, such as flow rate, pressure and the like in the hydrocarbon charging process; (2) recognizing that it is unilaterally stressed that a fracture acts as a fluid flow pattern of translocating system, not considering on the whole a configuration relation of fracture-karst cave as a study object for a hydrocarbon accumulation system in which karst caves act as a main reservoir space; (3) mostly studying how to improve a recovery factor of fracture-cavity reservoir, as a research objective, and rarely studying a hydrocarbon charging process and filling degree of hydrocarbon and hydrocarbon distribution; and (4) a physical simulation mainly based on two-dimensional model, which cannot embody a real situation of hydrocarbon migration in three-dimensional space.

### SUMMARY OF THE INVENTION

In view of the above-mentioned defects existing the prior art, it is an object of the present invention to propose a physical simulation method and experiment device of fracture-cavity carbonate reservoir hydrocarbon charge, enable to obtain a regularity of changes in filling degree of hydrocarbon inside karst caves under different karst cave-fracture configuration conditions, thereby obtaining regularities of distribution of oil, gas and water through parameters such as karst, fracture, density of crude oil and oil, gas and water distribution and the like.

The object of the present invention is achieved by the following technical solutions:

a physical simulation experiment device of fracture-cavity carbonate reservoir hydrocarbon charge comprising a fracture-cavity model, an experiment stand with windows, a wall rock and a camera monitoring system;

the fracture-cavity model comprises at least two simulation caves in different sizes and at least three simulation fractures in different sizes, and the simulation caves are connected to one another via the simulation fractures;

the experiment stand with windows is a casing-experiment stand, the fracture-cavity model is arranged inside the experiment stand with windows, and the simulation caves of at least one side of the fracture-cavity model are visual through the windows of the experiment stand;

a surrounding of the wall rock is arranged around the fracture-cavity model to simulate a formation of fracture-cavity carbonate reservoir;

the camera monitoring system is used for measuring and adjusting a change in flow rate and pressure in a charge process, and recording an image of fracture and cave in the charge process displayed in the windows.

According to the embodiments, in the above-mentioned physical simulation experiment device of fracture-cavity carbonate reservoir hydrocarbon charge, the experiment stand with windows is a casing-experiment stand, namely, a working region of the experiment stand is a casing, wherein the casing of the experiment stand may be reinforced tempered glass in its perimeter, namely, the windows are reinforced tempered glass. The experiment stand at least has one window.

In the abovementioned physical simulation experiment device of fracture-cavity carbonate reservoir hydrocarbon charge, it is preferable that, the simulation fracture in different sizes is a stainless steel connection tube of different lengths and micro diameters (very fine diameters, possibly in micron level).

In the abovementioned physical simulation experiment device of fracture-cavity carbonate reservoir hydrocarbon charge, it is preferable that, the wall rock is made of cement close to a wetting property of carbonatite.

In the abovementioned physical simulation experiment device of fracture-cavity carbonate reservoir hydrocarbon charge, it is preferable that, the camera monitoring system comprises a video camera, a monitor, a pressure flow sensor and a control valve; the video camera is used for capturing an image of fracture and cave in the charge process displayed in the windows;

the video camera is electrically connected to the monitor;

the pressure flow sensor and the control valve are arranged inside the simulation fracture pipeline (generally visual portion is a peripheral control end or a display window);

the pressure flow sensor and the control valve are electrically connected to the monitor.

In the abovementioned physical simulation experiment device of fracture-cavity carbonate reservoir hydrocarbon charge, the pressure flow sensor is used for transmitting experiment data in real time to the monitor through wireless devices, the monitor records information, such as changes in flow rate and pressure; the control valve is used for controlling fluid flow in a single fracture in experiment.

In the abovementioned physical simulation experiment device of fracture-cavity carbonate reservoir hydrocarbon charge, it is preferable that, the experiment device further comprises a control center, a pump, a water tank, an oil tank and a collector;

the control center is electrically connected to the pump, the pressure flow sensor and the control valve, respectively;

the pump is connected to the water tank, the oil tank, respectively; the water tank and the oil tank are connected to an injection end of the fracture-cavity model, respectively;

the collector is connected to a discharge end of the fracture-cavity model; and

preferably, the control center is a computer; the pump is a programmable hydraulic pump.

In the abovementioned physical simulation experiment device of fracture-cavity carbonate reservoir hydrocarbon charge, it is preferable that, the experiment device further comprises a gas tank that is connected to the injection end of the fracture-cavity model; and more preferably, the gas tank is one in which nitrogen is filled;

In the abovementioned physical simulation experiment device of fracture-cavity carbonate reservoir hydrocarbon charge, it is preferable that, the experiment device comprises a tilt angle adjusting mechanism that is arranged under the bottom of the experiment stand with windows.

In the abovementioned physical simulation experiment device of fracture-cavity carbonate reservoir hydrocarbon charge, a computer is a program control center, and mainly controls a fluid charge pressure and flow in the experiment process; a hydraulic pump mainly pumps fluid into an experimental model at a certain flow rate or pressure under the control of computer; a camera head mainly records the whole experiment process on the experiment stand, and transfers the result to the monitor; on one hand, the monitor records a video record of experiment process the camera head transmits; on the other hand, real-time data recorded by a flow-pressure sensor connected in the fracture-cavity system in an experimental model is recorded through a wireless device; the experiment stand is mainly used for loading the experimental model, wherein a plurality of sensors are installed on a physical model for acquiring change information of pressure and flow rate in experiment. Under the bottom of the experiment stand has a power tilt angle adjusting device for adjustment of model angle according to change in a dip angle desired based on the experiment.

In the process of experiments performed in use of the abovementioned physical simulation experiment device of fracture-cavity carbonate reservoir hydrocarbon charge, first adjusting a model, turning on a monitoring system, and then setting a flow rate or pressure of fluid charge. After an experiment starts, data such as, flow rate and pressure and the like are simultaneously recorded in real time when the experiment process is under the monitoring of the camera head. When a fluid reaches the maximum filling degree in all of the karst caves of the fracture-cavity system, an experiment ends until changes do not take place any more. In order to verify the reliability of experimental data, experiments are repeatedly conducted for parameter adjustment for the same model to compare the difference of the experimental result.

The present invention further provides a physical simulation method of fracture-cavity carbonate reservoir hydrocarbon charge, the above-mentioned physical simulation experiment device of fracture-cavity carbonate reservoir hydrocarbon charge comprises the steps of:

using drilling and three-dimensional seismic data for study of size and spatial distribution of karst cave, density of fracture distribution and spatial distribution feature inside the fracture-cavity system;

optimizing data in accordance with the geological phenomenon particularly dissected and size and spatial distribution of karst cave, density of fracture distribution and spatial distribution feature inside the relevant fracture-cavity system, creating a fracture-cavity model;

the physical simulation experiment device of fracture-cavity carbonate reservoir hydrocarbon charge for hydrocarbon charge runs a physical simulation of hydrocarbon charge (simulation of a three-dimensional fracture-cavity system), and monitors and records information such as changes in pressure, flow rate, filling degree and the like.

When a fluid for hydrocarbon charge reaches the maximum filling degree in all of the karst caves of the fracture-cavity system, an experiment ends until changes do not take place any more;

systematically analyzing the obtained parameter information and physical simulation result in view of the above proceedings, and specifying the filling degree of karst caves and regularities of distribution of oil, gas and water in the research region;

the abovementioned physical simulation method of fracture-cavity carbonate reservoir hydrocarbon charge can instruct an exploration deployment;

the abovementioned physical simulation method of fracture-cavity carbonate reservoir hydrocarbon charge starts a study of size, distribution and configuration relation of the actual karst fracture cavity in the research region, optimizes parameters and sets up a three-dimensional physical model mutually mated with the actual geological condition, runs a simulation relying on hydrocarbon charge physical simulation platform of fracture-cavity system within three-dimensional space on such a basis, and monitors and records important parameters such as pressure, flow rate and the like in real time. An advantage of this method lies in that experiments can be repeatedly conducted through changes in parameters such as injection pressure, injection rate, dip angle and the like to obtain a hydrocarbon charging process truly reflecting a geologic period.

In the abovementioned physical simulation method of fracture-cavity carbonate reservoir hydrocarbon charge, preferably, using drilling and three-dimensional seismic data and the like for study of size and spatial distribution of karst cave, density of fracture distribution and spatial distribution feature inside the fracture-cavity system (namely, distribution feature and density of fracture cavity cube) comprising:

obtaining a size and spatial distribution of fracture and cave following fine engraving relying on a coherent cube and a frequency division technique through well-to-seismic calibration and three-dimensional seismic data;

determining a development density of small-sized fracture through integrated imaging logger and fracture data;

obtaining a large-sized fracture distribution and density of distribution in conjunction with ant tracking; and

obtaining distribution density data of fracture cube by comprehensively setting up a three-dimensional fracture network, and hence obtaining a distribution feature and density of fracture cavity cube.

According to the embodiments, using drilling and three-dimensional seismic data and the like for study of size and spatial distribution of karst cave, density of fracture distribution and spatial deployment inside the fracture-cavity system, comprising:

(1). specifying regularities of distribution of sizes and space of karst caves in the fracture-cavity system, namely using three-dimensional seismics for meticulous depiction of karst caves, studying size of a single cave and further studying spatial distribution. This work is mainly combining drilling calibration, using a three-dimensional seismic data cube, relying on the coherent cube and frequency division technique to analyze the seismic imaging of karst caves, adopting multi-seismic attribute fusion technique for meticulously engraving the karst fracture cavity cube and obtaining a distribution scope and size of solution pore and cavity on this basis.

(2). specifying regularities of density and spatial distribution of fracture in the fracture-cavity system, namely, determining a density of fracture distribution in combination with drilling imaging logger and core fracture data, and further studying regularities of distribution of fracture in space in combination with a three-dimensional seismic fracture prediction method. This work is completed mainly relying on a combination of imaging logging technique and three-dimensional seismic technique. First of all, identifying and depicting fractures of different levels of high-accuracy three-dimensional seismics and fracture system through ant-tracking seismic fracture identification technique. On such a basis, analyzing a fracture distribution and density of stratum under study by applying an imaging logging technique, and correcting fracture data depicted by earthquake through the fractured result identified by imaging logging, and obtaining data of density of fracture distribution.

(3). combining the research achievements for karst caves and fractures in (1) and (2), fusing karst caves and fracture data into one seismic data cube by using a seismic attribute fusion technique, and comprehensively analyzing the space allocating relation of karst caves and fracture and classifying the same, as a model basis of physical simulation experiment.

In the physical simulation method of fracture-cavity carbonate reservoir hydrocarbon charge, the current stratum form is not the stratum distribution form in the hydrocarbon charge period, thus it needs to clearly determine the main geological period of hydrocarbon charge upon study of burial history and thermal evolution history, and through means such as analysis of inclusions and the like, and restoring a paleotopography in this period according to a backstripping method, and restoring a dip angle and terrain distribution characteristics in a hydrocarbon charge period in the research region, and taking this as a model basis of hydrocarbon charge in the physical simulation charge period. For instance, in the case of multiphase charge, the dip angle and terrain distribution characteristics at different charge periods shall be analyzed, respectively.

Preferably, optimizing data in accordance with the geological phenomenon particularly dissected and size and spatial distribution of karst cave, density of fracture distribution and spatial distribution characteristics inside the relevant fracture-cavity system, creating the physical simulation experiment device of fracture-cavity carbonate reservoir hydrocarbon charge, comprising:

combining the obtained size, spatial distribution feature and density of fracture and cave; determining the main geological period of hydrocarbon charge upon study of burial history and thermal evolution history, and through analysis of inclusions; and

restoring a paleotopography in the main geological period of this hydrocarbon charge according to a backstripping method, and restoring a dip angle and terrain distribution characteristics in the main geological period of this hydrocarbon charge, and taking this as a model basis of hydrocarbon charge in the physical simulation charge period, and creating a physical simulation experiment device of fracture-cavity carbonate reservoir hydrocarbon charge.

In the abovementioned physical simulation method of fracture-cavity carbonate reservoir hydrocarbon charge, preferably, when a hydrocarbon charge physical simulation is performed for the physical simulation experiment device of fracture-cavity carbonate reservoir hydrocarbon charge for hydrocarbon charge, when the simulated fracture-cavity carbonate reservoir is an oil-producing region, then a proportioning density corresponds to oil materials for experiment; when the simulated fracture-cavity carbonate reservoir is a gas-producing region, then nitrogen is selected as gas for experiment; based on whether the simulated fracture-cavity carbonate reservoir has oil field water, the physical simulation experiment device is selected to be in a saturated water state or maintained in an anhydrous state.

It indicates the simulated fracture-cavity carbonate reservoir has oil field water whether the physical simulation experiment device is selected to be in a saturated water state or maintained in an anhydrous state, based on whether the simulated fracture-cavity carbonate reservoir has oil field water, as mentioned above, the physical simulation experiment device is in a saturated water state; when the simulated fracture-cavity carbonate reservoir has no oil field water, the physical simulation experiment device is maintained anhydrous.

In the physical simulation method of fracture-cavity carbonate reservoir hydrocarbon charge, parameters obtained in the experiment process are significant data for conducting a research on carbonate fracture-cavity dual media reservoir percolation mechanism, can realize a simulation of hydrocarbon charge process approximate to the actual geological conditions, and monitor and record in real time changes in data, such as pressure, flow rate and the like in the hydrocarbon charging process, and analyze, under different geological conditions, the filling degree of the hydrocarbon inside the fracture-cavity system and the abundance of hydrocarbon distribution on this region on such a basis, recognize an impact of different fracture-cavity configuration relations and different charge conditions on a filling degree of hydrocarbon inside the fracture-cavity system and distribution in a lateral direction. It can obtain in conjunction with the experiment result that a concrete research region realizes a preference of final exploration-favorable zone, and improves a success ratio of exploration.

The present invention runs a physical simulation by using three-dimensional seismics in combination with drilling and logging data, relying on the physical simulation experiment device of fracture-cavity carbonate reservoir hydrocarbon charge, can change parameters such as flow rate of charge, pressure, inclination angle of model, opening state of fracture system, saturated water inside the model or not, and monitor and record changes in parameters such as pressure, flow rate and filling degree in real time in the process of hydrocarbon charge by experimenting a forward hydrocarbon charge process, and study the control effect of each element on the hydrocarbon charging process.

Use of the physical simulation method of fracture-cavity carbonate reservoir hydrocarbon charge in the present application can accurately observe and record the hydrocarbon charge process and changes in parameters inside the three-dimensional system in real time, as compared with the conventional method, it can reflect the actual geological conditions more accurately, and obtain reliable parameters, can provide reliable data and process record data for the theoretical research on fracture-cavity dual media percolation mechanism, this is a theoretical value of the present invention; simultaneously, it is possible to comprehensively evaluate the abundance of hydrocarbon distribution in the research region and instruct an exploration orientation in the case of few drilling wells, relying on this experimental data and the result, which realizes an application value of the present invention.

The outstanding effects of the present invention are:

the present invention monitors changes there between in parameters such as pressure, flow rate and filling degree and the like in real time in the process of hydrocarbon charge and those such as fluid viscosity, form of karst caves, fracture aperture and the like, by establishing a complete set of physical simulation experiment method of studying a karst fracture-cavity system hydrocarbon charge, and hence obtains regularities of change in filling degree of hydrocarbon inside the karst caves under different cave-fracture configuration conditions to achieve the object of recognizing regularities of distribution of oil, gas and water through parameters such as karst, fracture, density of crude oil, oil, gas and water distribution and the like.

The physical simulation method and experiment device of fracture-cavity carbonate reservoir hydrocarbon charge of the present invention have three advantages: (1). having a well-established real-time observation and data recording system, which can repeatedly simulate the hydrocarbon charging process of different fracture-cavity systems over multiple times, and obtain critical data, to provide data support for research on a percolation mechanism of fracture cavity system; (2). it is possible to simulate a cave system in different sizes, and overcome a limitation of core etching and glass etching physical simulation in the characterized dimension and representativeness; and (3). it is possible to set up a three-dimensional model to simulate hydrocarbon mobility situation in multi-dimensional space, and simulate the hydrocarbon charge process approximate to the actual geological conditions.

### BRIEF DESCRIPTION OF THE DRAWINGS

FIG. 1 is a structural schematic diagram of physical simulation experiment device of fracture-cavity carbonate reservoir hydrocarbon charge in Example 1;

FIG. 2 is a flowchart of physical simulation method of fracture-cavity carbonate reservoir hydrocarbon charge in Example 2;

FIG. 3 is a “bead-type” seismic reflection diagram of karst cave in Halahatang region in Example 2;

FIG. 4 is a three-dimensional seismic recognition diagram of karst cave in Halahatang region in Example 2;

FIG. 5 is a three-dimensional seismic engraving diagram of fracture system in Halahatang region in Example 2;

FIG. 6 is a configuration relation diagram of fracture cavity system in Halahatang region in Example 2;

FIG. 7 is a configuration relation classification chart of fracture cavity system in Halahatang region in Example 2;

FIGS. 8a, 8b, 8c are fluorescent characteristic diagrams of typical petroleum inclusions in Halahatang region in Example 2;

FIG. 9 is fluorescent distribution characteristic diagram of inclusions in Halahatang region and the adjacent region in Example 2;

FIG. 10a is a relationship diagram between wavelength of a main peak (λ max) and fluorescence intensity (Imax) for microbeam fluorescence spectrum of typical petroleum inclusions in Halahatang region in Example 2;

FIG. 10b is a relationship diagram between wavelength of a main peak (λ max) and red-green quotient (Q=I650/I500) of microbeam fluorescence spectrum of typical petroleum inclusions in Halahatang region in Example2;

FIG. 11 is a history of hydrocarbon charge in Halahatang region in Example 2;

FIG. 12 is an ancient landform recovery of Halahatang region and adjacent regions in Example 2;

FIG. 13 is an anhydrous hydrocarbon charge result of multilayer fracture cavity system in Halahatang region in Example 2;

FIG. 14 is a petroleum charging process of fracture cavity system in a saturated-water state in Halahatang region in Example 2;

FIG. 15 is a schematic diagram of control elements in the scope of hydrocarbon charge for fracture cavity system in Example 2;

FIG. 16 is a hydrocarbon drilling situation at later phases in Halahatang region in Example 2.

### DETAILED DESCRIPTION OF THE INVENTION

In order to more clearly understand technical features, objects and advantageous effects of the present invention, the technical solution of the present invention is currently explained in detail below, but cannot be construed as limiting a practical range of the present invention. The test methods in the following Examples, unless otherwise indicated, each is a conventional method; the reagent and material, unless otherwise indicated, each can be commercially available.

### EXAMPLE 1

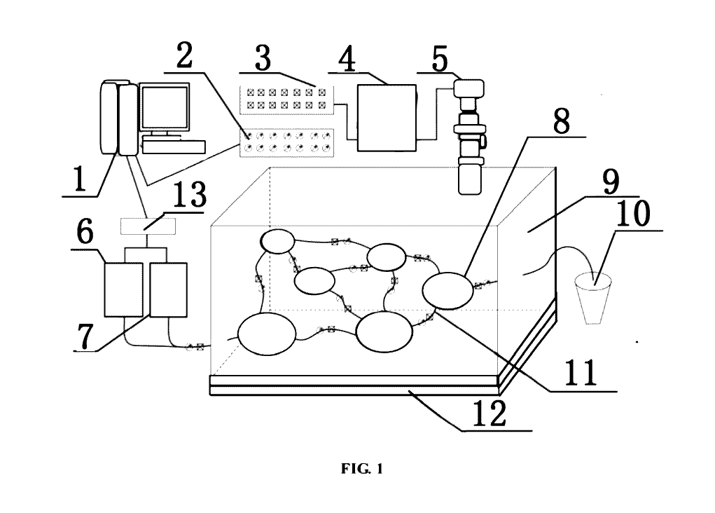

This Example provides a physical simulation experiment device of fracture-cavity carbonate reservoir hydrocarbon charge, as shown in FIG. 1, the experiment device comprises a fracture-cavity model, an experiment stand with windows 9, a wall rock, a tilt angle adjusting mechanism 12, a camera monitoring system, a control center (computer) 1, a pump (programmable hydraulic pump) 13, a water tank 6, an oil tank 7 and a collector 10; a camera monitoring system comprises a video camera 5, a monitor 4, a pressure flow sensor 3 and a control valve 2; the video camera 5 is used for capturing an image of fracture and cave in the charge process displayed in the windows; the video camera 5 is electrically connected to the monitor 4; the pressure flow sensor 3 and the control valve 2 are arranged inside the simulation fracture 11 pipeline; the pressure flow sensor 3 and the control valve 2 are electrically connected to the monitor 4.

The fracture-cavity model comprises a plurality of simulation caves 8 in different sizes and a plurality of simulation fractures 11 in different sizes, and the simulation caves 8 are connected to one another via the simulation fractures 11; the fracture-cavity model is arranged inside the experiment stand with windows 9, and the simulation caves 8 of at least one side of fracture-cavity model are visual through the windows of the experiment stand; a surrounding of wall rock is arranged around the fracture-cavity model to simulate a formation of fracture-cavity carbonate reservoir; a control center 1 is electrically connected to a pump 13, a pressure flow sensor 3 and a control valve 2, respectively; a pump 13 is connected to a water tank 6, an oil tank 7, respectively; the water tank 6 and the oil tank 7 are connected to an injection end of the fracture-cavity model, respectively; a collector 10 is connected to a discharge end of the fracture-cavity model; and a tilt angle adjusting mechanism 12 is arranged under the bottom of the experiment stand with windows 9.

### EXAMPLE 2

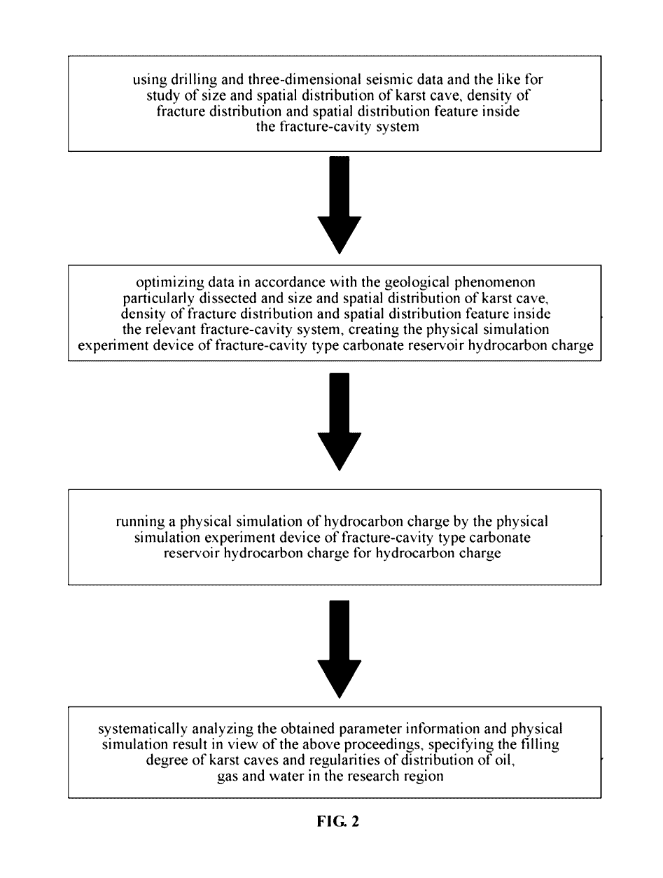

This Example provides a physical simulation method of fracture-cavity carbonate reservoir hydrocarbon charge, as shown in FIG. 2, which uses the physical simulation experiment device of fracture-cavity carbonate reservoir hydrocarbon charge in Example 1, and takes Halahatang research region, Tabei area, Tarim Basin as an example, comprising the steps of:

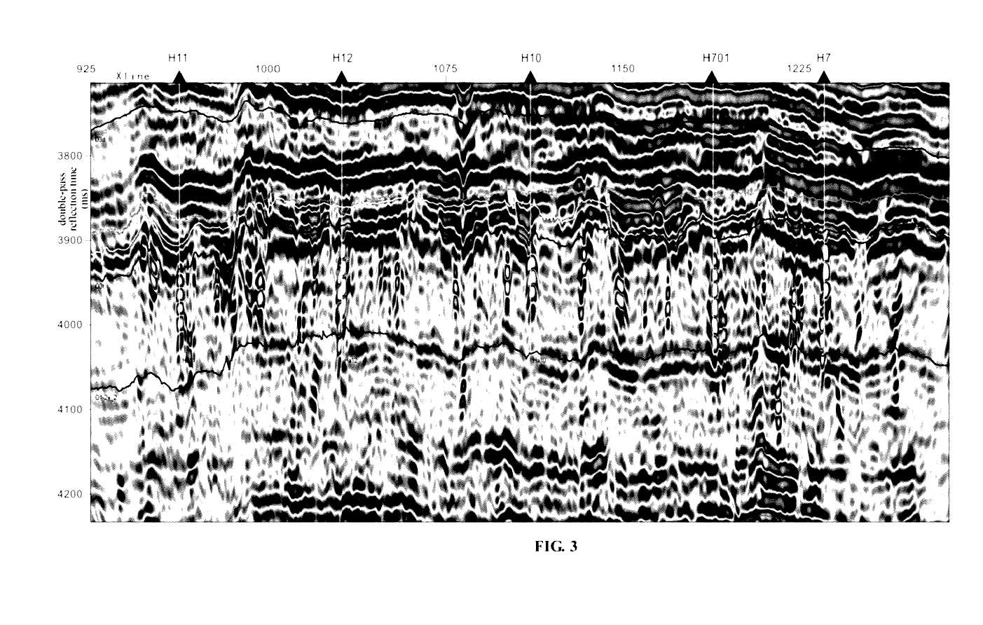

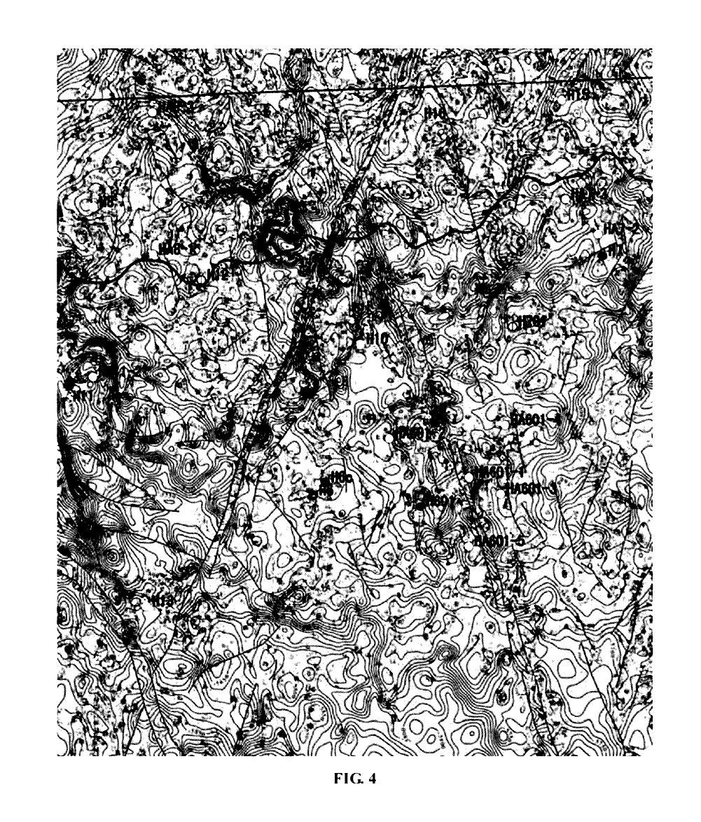

following an analysis of high-resolution seismic imaging and drilling for the research region, karst caves in this region are shown as a “bead-type” reflection on three-dimensional seismics, the “bead-type” seismic reflection forms differently reflect the difference in size and distribution of karst caves, as shown in FIG. 3, after the size of karst caves can be calibrated through an amount of loss of the existing drilling, a karst cave having a 0.5 ms reflection form on seismic section is finally obtained, and a depiction of karst caves is quantitatively calculated in conjunction with distribution of three-dimensional seismics in the plane, a height of the cave is about 20 m, and a length is between 100 m to 200 m, applicable to a physical model in the corresponding proportion. Regularities of distribution for karst caves in the research region are obtained by meticulously engraving the “bead-type” seismic reflection through the coherency cub technique and frequency division technique, as shown in FIG. 4, generally, karst caves are mostly widely distributed in the northern karst exposure area and the adjacent area, followed by in the vicinity of X-type fracture system.

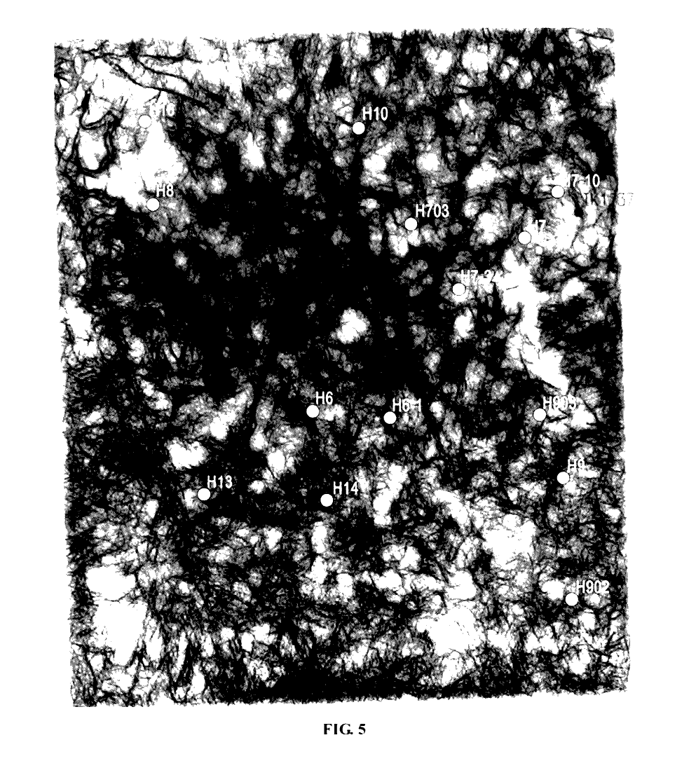

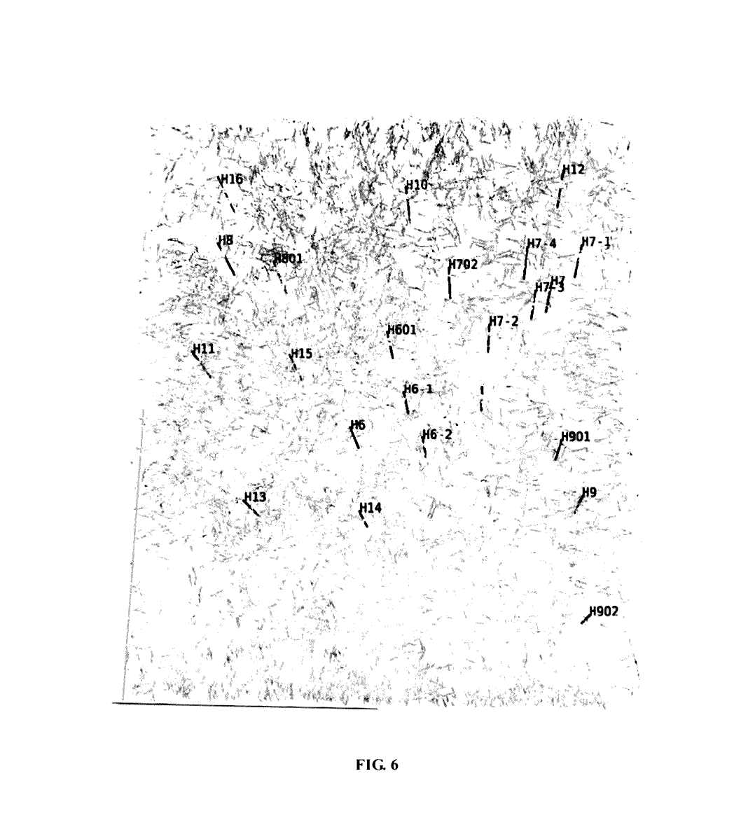

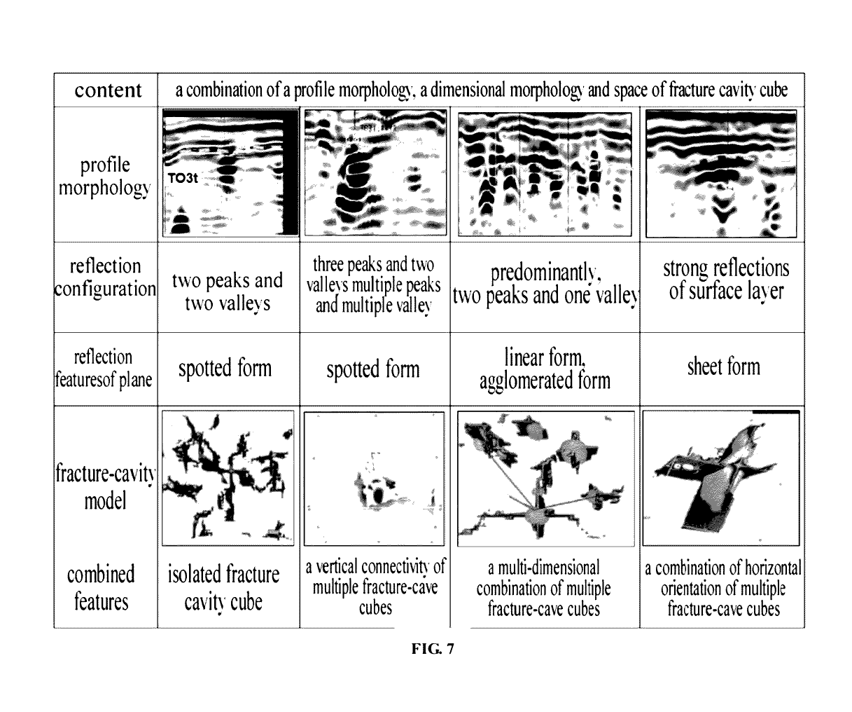

Regularities of distribution for fracture system in the research region are obtained by meticulously engraving the fractures in three-dimensional seismic cube through the coherency cub technique and fracture identification technique, as shown in FIG. 5. A fracture distribution is generally controlled by X-type shear fracture, and the X-type fracture and the neighboring fractures of conjugation fracture are developed the most. After depicting karst caves and fracture system, respectively, two seismic data cubes are fused in seismic data fusion technique to reflect a configuration relation of fracture cavity system, as shown in FIG. 6. On such a basis, setting up a fracture cavity configuration relation plate of the research region, namely, obtaining a distribution feature and density of the fracture cavity cube. A fracture cavity configuration relation is divided into 4 classes, as shown in FIG. 7, which reflects different configuration relations of fractures and caves.

In a fracture-cavity type reservoir, karst caves are reserving space, fractures are dredging systems, thus a fracture cavity configuration relation has an important impact on hydrocarbon charge, fracture-cavity space lacking communication by fractures is unfavorable for hydrocarbon accumulation, and the filling degree of karst caves in which fractures are overdeveloped is controlled by a location where a fracture develops, the position of the fracture above the karst caves would result in an overflow of hydrocarbon, only the best fracture-cavity configuration relation is in favour of the best filling degree existing in karst caves. After having established a configuration relation plate of fracture cavity in the research region, a physical simulation model (fracture-cavity model) is created.

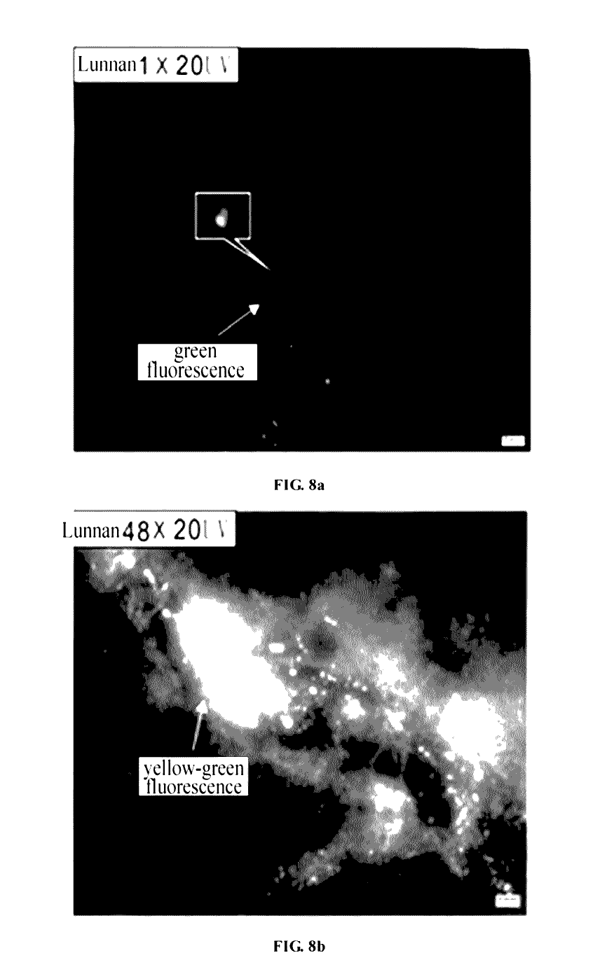

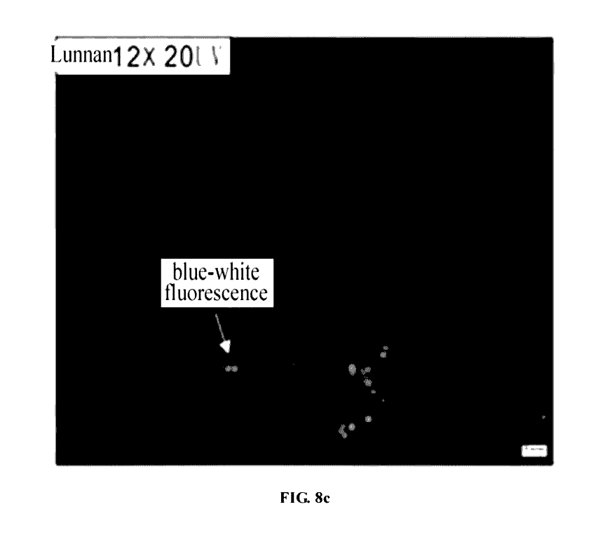

Specifically, when a physical simulation model (e.g., the physical simulation experiment device of fracture-cavity carbonate reservoir hydrocarbon charge in Example 1) is created, the main geological period of hydrocarbon charge is determined through burial history and thermal history in conjunction with means such as analysis of inclusions and the like, a fluorescence intensity and spectrum character are measured with greater accuracy on the basis of observation of fluorescent color of petroleum inclusions, mainly dependent on characteristics of fluorescent spectrum of petroleum inclusions, so as to obtain more information on hydrocarbon. Along with a reduction in value of main peak of spectrum, there exists a “blue shift” phenomenon in its fluorescence, and the maturity of petroleum inclusions increases; otherwise, the main peak value increases, there exists a “red shift” in the fluorescence, and the maturity of petroleum inclusions reduces, it is indicated under a mirror in which 38 pieces of fluid inclusions double-sided polished thin sheets are used that petroleum inclusions are found in calcite vein lattice imperfection of limestone in a karst reservoir section, and mainly fluoresce green, yellow-green and blue-white under the ultraviolet light, as shown in FIGS. 8a, 8b, 8c. Wherein green and blue-white fluorescent inclusions are mainly distributed in the eastern region, while yellow-green fluorescent inclusions are mainly based in the western region, as shown in FIG. 9, the difference of this distribution is not only related to source of hydrocarbon, but also closely related to the maturity of hydrocarbon in different regions.

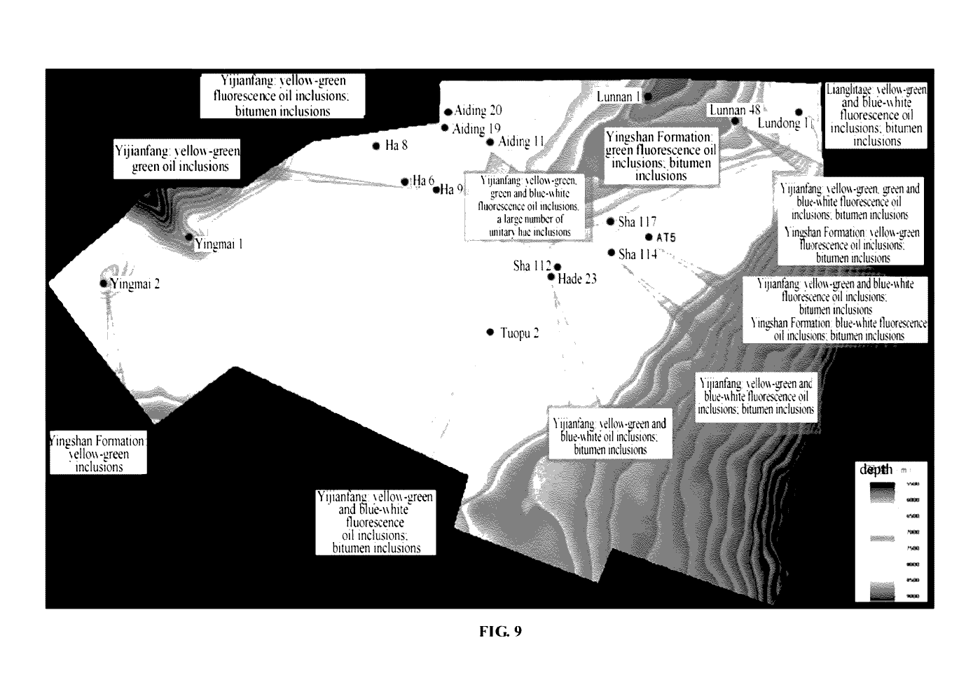

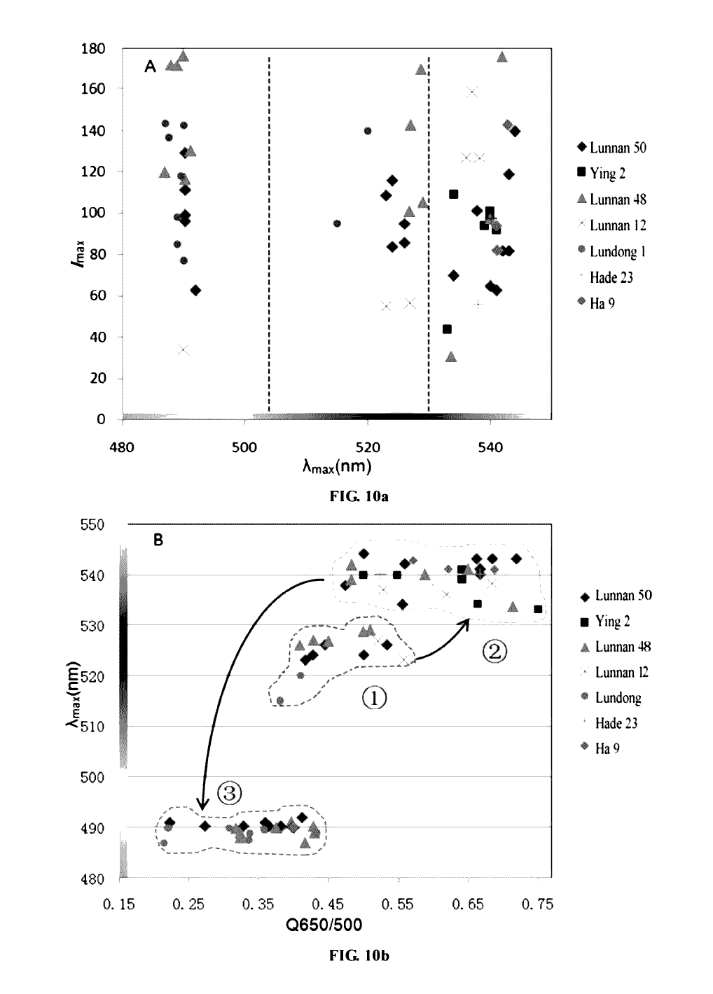

Fluorescence intensity of petroleum inclusions is closely related to the density of petroleum in the inclusions and the like, there may be a larger difference in its fluorescence intensity for charging in different periods and oil from different oil sources, thus a qualitative determination is made by using the difference of fluorescence intensity in general to judge the property of oil in the petroleum inclusions. In this research, all fluorescence intensities (Imax) corresponding to three fluorescence colors have a larger distribution range, as shown in FIG. 10a, the Imax of blue-white fluorescence spectrum (a wavelength of a main peak is between 447.1 nm to 492 nm) is intensively distributed between 63.5-143.8, the Imax of green fluorescence spectrum (a wavelength of a main peak is between 515 nm to 526 nm) is intensively distributed between 81.3-142.5, and the Imax of yellow-green fluorescence spectrum (a wavelength of a main peak is between 533 nm to 544 nm) is intensively distributed between 50.3-135.2. The wide distribution range of the Imax sufficiently demonstrates plural-sources and plural-phases charge of hydrocarbon in this region and a relative change in elements resulting from fractionation, oxidation and the like in the process of hydrocarbon migration and accumulation.

As shown in FIG. 10b, the red-green quotients (Q) corresponding to the three fluorescence spectrums are shown as three data groups, wherein the red-green quotient (Q) of blue and white fluorescence spectrum is intensively distributed between 0.21-0.45, the red-green quotient (Q) of green fluorescence spectrum is intensively distributed between 0.38-0.57, and the red-green quotient (Q) of yellow-green fluorescence spectrum is intensively distributed between 0.47-0.75. It is possible to judge that south slope region, Tabei area at least experienced hydrocarbon charge for three phases in the geologically historical period in conjunction with the main peak wavelength λ max feature of microbeam fluorescence spectrum of petroleum inclusions, and λ max-Imax relevant analysis and λ max-Q relevant analysis.

Three data groups in λ max-Q relevant analysis represent hydrocarbon charge for three phases different in maturities, wherein the yellow-green fluorescence oil inclusions have the minimum maturity, and are widely distributed, and the blue-white fluorescence oil inclusions having the highest maturity are mainly distributed in the sample of Lungu region, and the green oil inclusions having a maturity therebetween generally exist in the sample in a region to the east of Halahatang region, such as Ha9 well and the like, which can substantially demonstrate the scope of hydrocarbon charge for three phases.

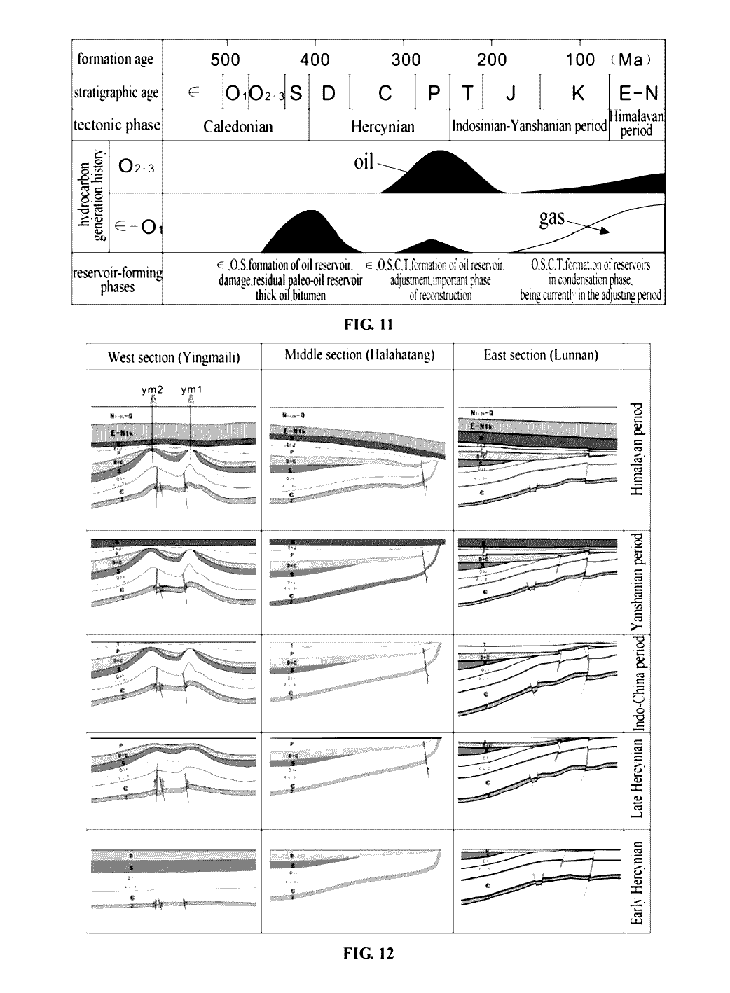

It is believed in combination of structural evolution history restoration and the former achievements that a reservoir-formation evolution history of south slope region, Tabei area should be a three-phase reservoir formation, the reservoir formation history thereof and the characteristics of fluorescence spectrum evolution of inclusions are as follows (as shown in FIGS. 10b, 11, the phase number of the numbers (1) to (3) in both figures corresponds to one another): in late Caledonian-early Hercynian period, a reservoir was formed in Upper Cambrian-Lower Ordovician, and a large amount of green fluorescence oil inclusions were formed, the distribution scope thereof was at least a region to the east of Ha 9 wells; in late Hercynian, oil production was initiated in middle and upper Ordovician, yellow-green fluorescence inclusions are captured in reservoirs in this period, widely distributed throughout the entire south slope region; in himalayan period, hydrocarbon production was resumed in middle and upper Ordovician and blue-white fluorescence oil inclusions that represent a high maturity were formed in the formation, the range of reservoir forming in this period was bound to Lunnan Lower Uplift and the region to the east. Thus, a physical simulation is made by recovering late Caledonian and early Hercynian palaeoburial form, which can truly reflect the paleotopography of hydrocarbon charge in Halahatang region. It is believed that this regional structural distortion is divided into three sections by recovering the structural evolution of Tabei Area, Tarim Basin, as shown in FIG. 12, wherein the eastern, and western structural distortions are relatively stronger, and the research region—Halahatang region has a relatively stable structural distortion. In the main charge period of hydrocarbon, namely, early Hercynian period, a ramp where lower in the south and higher in the north is formed on the whole, the slope is 30-35° on top Ordovician ramp, so as to provide terrain parameters for physical simulation. Meanwhile, it is believed by recovering the structure that the main fractures and karst reservoirs of this region in this period are substantially shaped, and consistent with the current situation, therefore, a research on fractures and paleokarst-caves can be obtained and determined according to three-dimensional seismic information.

After obtaining above-mentioned basis, creating a physical simulation experiment device of fracture-cavity carbonate reservoir hydrocarbon charge.

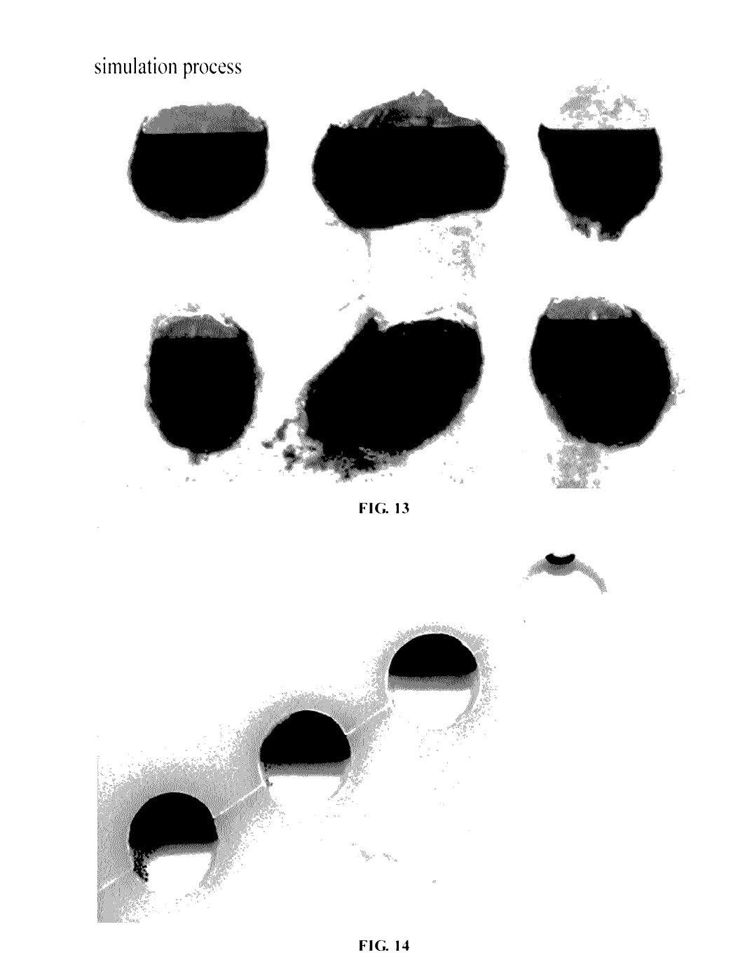

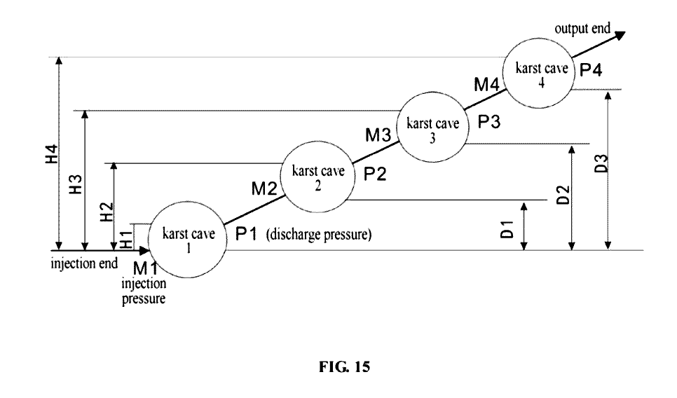

A simulation is made on the physical simulation experiment device of fracture-cavity carbonate reservoir hydrocarbon charge, and changes in pressure, flow rate, filling degree are monitored and recorded. When a fluid for hydrocarbon charge reaches the maximum filling degree in all of the karst caves of the fracture-cavity system, an experiment ends until changes do not take place any more; the simulation results are as shown in FIGS. 13 and 14, wherein FIG. 13 is an anhydrous hydrocarbon charge result of multilayer fracture cavity system in Halahatang region, and FIG. 14 is a petroleum charging process of fracture cavity system in a saturated-water state in Halahatang region.

Wherein petroleum is substantially accumulatively located at the bottom of karst caves in an anhydrous state, and fully filled gradually upwardly, the filling degree of petroleum in the fracture cavity system is under control of charging pressure and output end position, wherein the output end position determines the maximum liquid-column height of petroleum inside a single karst cave (the height of from the bottom of karst cave to an output end), and the charging pressure decides a scope that petroleum spreads in the fracture cavity system; in a saturated-water phase, petroleum that is subject to buoyancy control of water body mainly gathers at the top of karst caves, and is accumulated by draining downwardly the driving water body, the filling degree of petroleum in the fracture cavity system is also subject to control of injection pressure, output end position, wherein the position of the output end decides the maximum liquid-column height of petroleum (the height of from the bottom of karst cave to an output end) in a single karst cave, and the charging pressure decides a scope that petroleum spreads in the fracture cavity system; As regards the relation between the scope of hydrocarbon charge and charging pressure as shown in FIG. 15, it is closely related to the difference of fluid-column pressure between an injection end and an output end. In the case of ρgD1>M1−P1>ρgH1, hydrocarbon cannot be transferred to the karst cave 2 and the karst caves afterwards, and in the case of ρgD2>M2−P2 >ρgH2, hydrocarbon cannot be transferred to the karst cave 3 and the karst caves afterwards, and so on, only in the case of M1−P4>ρgH4, hydrocarbon can be charged and spread in the whole system (note: ρ*g*H refers to pressure produced by fluid-column, wherein ρ is fluid density; g is acceleration of gravity; H is liquid-column height).

The simulation result shows that the filling degree of hydrocarbon in this research region is controlled by the distribution scope of basal water and development degree of fractures.

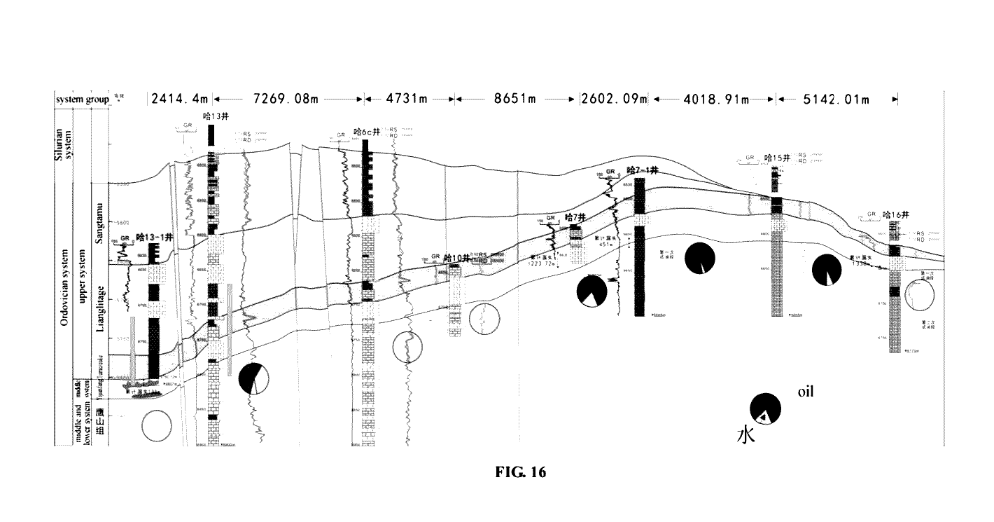

In the case of few drilling wells, regularities of distribution of hydrocarbon in an exploration region can be predicted through the physical simulation experiment result, and the simulation result can be verified through late drilling. The result of late drilling is as shown in FIG. 16.

In the method of this Example, a research was made on the process of karst fracture-cavity system hydrocarbon charge in Halahatang exploration region, Tabei area, Tarim Basin. The research shows that a geological model of fracture cavity system in the research region can be rapidly established by using the method of the present Example in conjunction with high-resolution three-dimensional seismic body and drilling data, and a simulation of the process of hydrocarbon charge is run through a physical simulation platform of three-dimensional fracture cavity system hydrocarbon charge, and the relevant parameters for research on percolation mechanism of fracture cavity system are obtained.

As can be seen, Examples of the present invention monitor changes therebetween in parameters such as pressure, flow rate and filling degree and the like in real time in the process of hydrocarbon charge and those such as fluid viscosity, form of karst caves, fracture aperture and the like, by establishing a complete set of physical simulation experiment method for study of karst fracture-cavity system hydrocarbon charge, and hence obtain regularities of changes in filling degree of hydrocarbon inside the karst caves under different cave-fracture configuration conditions to achieve the object of recognizing regularities of distribution of oil, gas and water through parameters such as karst, fracture, density of crude oil and oil, gas and water distribution and the like, so as to instruct an exploration orientation.

What is claimed is:

1. A physical simulation experiment device of fracture-cavity carbonate reservoir hydrocarbon charge comprising a fracture-cavity model, an experiment stand with windows, a wall rock and a camera monitoring system;
wherein the fracture-cavity model comprises at least two simulation caves in different sizes and at least three simulation fractures in different sizes, and the simulation caves are connected to one another via the simulation fractures;
wherein the experiment stand with windows is a casing-experiment stand, the fracture-cavity model is arranged inside the experiment stand with windows, and the simulation caves of at least one side of the fracture-cavity model are visual through the window of the experiment stand;
wherein the wall rock has a surrounding that is arranged around the fracture-cavity model to simulate a formation of fracture-cavity carbonate reservoir;
wherein the camera monitoring system is used for measuring and adjusting a change in flow rate and pressure in a charge process, and recording an image of fracture and cave in the charge process displayed in the windows.

2. The physical simulation experiment device of fracture-cavity carbonate reservoir hydrocarbon charge according to claim 1, wherein the simulation fractures in different sizes are stainless steel connection tubes of different lengths and micro diameters.

3. The physical simulation experiment device of fracture-cavity carbonate reservoir hydrocarbon charge according to claim 1, wherein the camera monitoring system comprises a video camera, a monitor, a pressure flow sensor and a control valve;
wherein the video camera is used for capturing an image of the fracture and cave in the charge process displayed in the windows;
wherein the video camera is electrically connected to the monitor;
wherein the pressure flow sensor and the control valve are arranged inside the simulation fracture pipeline; and
wherein the pressure flow sensor and the control valve are electrically connected to the monitor.

4. The physical simulation experiment device of fracture-cavity carbonate reservoir hydrocarbon charge according to claim 1, wherein the experiment device further comprises a control center, a pump, a water tank, an oil tank and a collector;
wherein the control center is electrically connected to the pump, the pressure flow sensor and the control valve, respectively;
wherein the pump is connected to the water tank, the oil tank, respectively;
wherein the water tank and the oil tank are connected to an injection end of the fracture-cavity model, respectively; and
wherein the collector is connected to a discharge end of the fracture-cavity model.

5. The physical simulation experiment device of fracture-cavity carbonate reservoir hydrocarbon charge according to claim 4, wherein the experiment device further comprises a gas tank that is connected to the injection end of the fracture-cavity model.

6. The physical simulation experiment device of fracture-cavity carbonate reservoir hydrocarbon charge according to claim 1, wherein the experiment device comprises a tilt angle adjusting mechanism that is arranged under the bottom of the experiment stand with windows.

7. A physical simulation method of fracture-cavity carbonate reservoir hydrocarbon charge, which adopts the physical simulation experiment device of fracture-cavity carbonate reservoir hydrocarbon charge according to claim 1, comprising the steps of:
using drilling and three-dimensional seismic data for study of size and spatial distribution of karst cave, density of fracture distribution and spatial distribution feature inside the fracture-cavity system;
optimizing data in accordance with the geological phenomenon particularly dissected and size and spatial distribution of karst cave, density of fracture distribution and spatial distribution feature inside the relevant fracture-cavity system, creating a fracture-cavity model;
the physical simulation experiment device of fracture-cavity carbonate reservoir hydrocarbon charge for hydrocarbon charge, runs a physical simulation of hydrocarbon charge, and monitors and records changes in pressure, flow rate, filling degree. When a fluid for hydrocarbon charge reaches the maximum filling degree in all of the karst caves of the fracture-cavity system, an experiment ends until changes do not take place any more;
systematically analyzing the obtained parameter information and physical simulation result in view of the above proceedings, and specifying the filling degree of karst caves and regularities of distribution of oil, gas and water in a research region.

8. The physical simulation method of fracture-cavity carbonate reservoir hydrocarbon charge according to claim 7, wherein using drilling and three-dimensional seismic data and the like for study of size and spatial distribution of karst cave, density of fracture distribution and spatial distribution feature inside the fracture-cavity system, comprising:
obtaining a size and spatial distribution of fracture and cave following fine engraving, through well to seismic calibration and three-dimensional seismic data, relying on a coherent cube and a frequency division technique;
determining a development density of small-sized fracture through integrated imaging logger and fracture data;
obtaining a large-sized fracture distribution and density of distribution in conjunction with ant tracking; and
obtaining distribution density data of fracture cube by comprehensively setting up a three-dimensional fracture network, and hence obtaining a distribution feature and density of fracture cavity cube.

9. The physical simulation method of fracture-cavity carbonate reservoir hydrocarbon charge according to claim 7, wherein optimizing data in accordance with the geological phenomenon particularly dissected and size and spatial distribution of karst cave, density of fracture distribution and spatial distribution feature inside the relevant fracture-cavity system, creating the physical simulation experiment device of fracture-cavity carbonate reservoir hydrocarbon charge, comprising:
combining the obtained size, spatial distribution feature and density of fracture and cave;
determining the main geological period of hydrocarbon charge upon study of burial history and thermal evolution history, and through analysis of inclusions; and
restoring a paleotopography in the main geological period of this hydrocarbon charge according to a backstripping method, restoring a dip angle and geomorphic distribution feature in the main geological period of this hydrocarbon charge, and taking this as a model basis of hydrocarbon charge in the physical simulation charge period, and creating a physical simulation experiment device of fracture-cavity carbonate reservoir hydrocarbon charge.

10. The physical simulation method of fracture-cavity carbonate reservoir hydrocarbon charge according to claim 7, wherein when a hydrocarbon charge physical simulation is performed for the physical simulation experiment device of fracture-cavity carbonate reservoir hydrocarbon charge for hydrocarbon charge, when the simulated fracture-cavity carbonate reservoir is an oil-producing region, then a proportioning density corresponds to oil materials for experiment; when the simulated fracture-cavity carbonate reservoir is a gas-producing region, then nitrogen is selected as gas for experiment; based on whether the simulated fracture-cavity carbonate reservoir has oil field water, the physical simulation experiment device is selected to be in a saturated water state or maintained in an anhydrous state.

11. The physical simulation method of fracture-cavity carbonate reservoir hydrocarbon charge according to claim 2, wherein the wall rock is made of cement close to a wetting property of carbonatite.

12. The physical simulation method of fracture-cavity carbonate reservoir hydrocarbon charge according to claim 4, wherein the control center is a computer.

13. The physical simulation method of fracture-cavity carbonate reservoir hydrocarbon charge according to claim 4, wherein the pump is a programmable hydraulic pump.

14. The physical simulation method of fracture-cavity carbonate reservoir hydrocarbon charge according to claim 5, wherein the gas tank is one in which nitrogen is filled.
